(19) United States
(12) Patent Application Publication
(10) Pub. No.: US 2025/0073680 A1
(43) Pub. Date: Mar. 6, 2025

(54) METHOD OF REGENERATING BIS(IMINOGUANIDINE) CARBON DIOXIDE SORBENTS FROM CARBONATE OR BICARBONATE SALT THEREOF

(71) Applicant: UT-Battelle, LLC, Oak Ridge, TN (US)

(72) Inventors: Gyoung Gug Jang, Knoxville, TN (US); Constantinos Tsouris, Oak Ridge, TN (US); Radu Custelcean, Knoxville, TN (US); Abishek Kasturi, Knoxville, TN (US); Kai Li, Oak Ridge, TN (US); Diana Stamberga, Lenoir City, TN (US); Kashif Nawaz, Knoxville, TN (US)

(21) Appl. No.: 18/816,522

(22) Filed: Aug. 27, 2024

Related U.S. Application Data
(60) Provisional application No. 63/534,893, filed on Aug. 28, 2023.

(51) Int. Cl. B01J 20/34; B01J 20/22

(52) U.S. Cl. CPC B01J 20/3475; B01J 20/22

(57) ABSTRACT

A method for regenerating a bis(iminoguanidine) (BIG) carbon dioxide sorbent, the method comprising: (i) providing a carbonate or bicarbonate salt of the BIG carbon dioxide sorbent, and (ii) directly contacting the carbonate or bicarbonate salt of the BIG carbon dioxide sorbent with steam heated to a temperature within a range of 80° C.-130° C. to result in regeneration of the BIG carbon dioxide sorbent with simultaneous conversion of the carbonate or bicarbonate anions into carbon dioxide, wherein the regenerated BIG carbon dioxide sorbent is substantially removed of carbonate or bicarbonate and may optionally contain one or more adduct water molecules. In some processes, the regenerated BIG carbon dioxide sorbent is dissolved in water condensing from the steam during the contacting step to form an aqueous solution of the regenerated BIG carbon dioxide sorbent.

### CROSS REFERENCE TO RELATED APPLICATION

The present application claims benefit of U.S. Provisional Application No. 63/534,893, filed on Aug. 28, 2023, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to methods for regenerating bis(iminoguanidine) (BIG) carbon dioxide sorbents from carbonate and bicarbonate salts of the sorbents. The present invention further relates to the capture of carbon dioxide using BIG sorbents and production of the carbonate and bicarbonate salts of such sorbents.

### BACKGROUND

Bis(iminoguanidine) (BIG) compounds are a promising class of carbon dioxide (CO₂) sorbents capable of capturing CO₂ from ambient air and binding it as a crystalline hydrated carbonate or bicarbonate salt. Three well known BIG compounds used for this purpose are 2,6-pyridine bis(iminoguanidine) (PyBIG), glyoxal-bis(iminoguanidine) (GBIG), and methylglyoxal-bis(iminoguanidine) (MGBIG). In some conventional systems, the BIG compound is used as a direct air capture (DAC) sorbent, often accomplished by combining the BIG sorbent with a traditional reactive aqueous sorbent, such as an organoamine or amino acid, which rapidly absorbs atmospheric CO₂ and converts it into a carbonate or bicarbonate salt. The carbonate or bicarbonate formed in the solution is captured by the BIG compound to result in the formation of hydrated BIG carbonate or bicarbonate crystals. These carbonate or bicarbonate salt crystals are then separated from the solution. Some examples of carbonate or bicarbonate salts of these BIG compounds include PyBIGH₂(CO₃)(H₂O)₄, GBIGH₂(HCO₃)₂(H₂O)₂, and MGBIGH₂(CO₃)₂(H₂O)₂, respectively.

The CO₂ contained within the carbonate or bicarbonate salt can be released by heating the carbonate or bicarbonate salt crystals in the solid state. The release of the CO₂ also typically leads to the regeneration of the BIG sorbent, which can then be reused in a subsequent cycle. However, a primary obstacle in conventional regeneration processes is the prohibitive cost. For example, the energy required for the regeneration of MGBIG carbonate is generally known to be in the range of 7.0-10.2 kJ/g-CO₂. Each molecule of MGBIG releases one molecule of CO₂ and three molecules of H₂O during thermal regeneration. A breakthrough in achieving low-energy regeneration would involve releasing only CO₂ molecules while retaining H₂O molecules bound with the BIG compound, but such a process has remained elusive. Other obstacles include non-uniform conductive heat transfer within the bulk solid, slow heat transfer leading to slow desorption kinetics, inefficient regeneration, and high risk of sorbent degradation. A process that could overcome any of these issues would make carbon capture and regeneration processes more feasible for large scale operations.

### SUMMARY

The present disclosure describes a method for regenerating a bis(iminoguanidine) (BIG) carbon dioxide sorbent from a corresponding carbonate or bicarbonate salt. The regeneration method is advantageously lower in cost and more energy efficient than conventional processes. The method can also achieve a substantially faster regeneration rate (e.g., two, three, four, or five times) compared to convection heating methods. The method achieves this by direct steam stripping of BIG sorbents. This approach significantly increases the regeneration rate, simplifies the overall CO₂ capture process, and reduces energy costs compared to conventional conductive thermal regeneration. As discussed later in this application, as a proof of concept, a direct-steam sorbent regeneration (DSR) reactor efficiently regenerated solid bis(iminoguanidines) (BIGs), such as methylglyoxal-bis(iminoguanidine) (MGBIG), with up to ˜99% recovery by direct steam exposure at about 100° C.

More particularly, the method includes the step of directly contacting the carbonate or bicarbonate salt of the BIG carbon dioxide sorbent with steam heated to a temperature within a range of 80° C.-130° C. to result in regeneration of the BIG carbon dioxide sorbent with simultaneous conversion of the carbonate or bicarbonate anions into carbon dioxide. In the process, the regenerated BIG carbon dioxide sorbent is substantially removed of carbonate or bicarbonate and may optionally contain one or more adduct water molecules. The carbonate or bicarbonate salt of the BIG carbon dioxide sorbent may have a structure of the Formula (1a), as described later in this application, and the regenerated (removed of carbonate or bicarbonate) BIG carbon dioxide sorbent may have a structure of the Formula (1b), as also described later in this application.

In particular embodiments, using low temperature direct steam heating, a 3.5 times faster regeneration rate of the MGBIG sorbent (e.g., 30 minutes for 10 g) was demonstrated compared to the time needed for conductive heating regeneration (e.g., 110 minutes for 10 g) at 160° C. Additionally, fully regenerated MGBIG can be converted into an aqueous MGBIG solution when the steam condenses onto the solid surface. This condensed steam, aqueous solution, can be easily recycled into the contactor upstream to achieve a continuous-flow direct-air-capture process. Enhanced mass transfer facilitated by low-temperature steam and subsequent condensation effectively heats up CO₂-binding molecules (i.e., carbonate-water complexes) within BIG-carbonate crystals under water-rich conditions, which facilitates the desorption of CO₂ from the solid crystals and leads to fast, effective, and energy-efficient sorbent regeneration. The full regeneration of BIG sorbents via direct steam stripping, as demonstrated in this disclosure, represents a significant advance toward a large scale and cost-effective method of carbon dioxide capture.

### BRIEF DESCRIPTION OF THE DRAWINGS

FIGS. 1a-1b. Schematic diagrams showing CO₂ capture cycles based on crystallization of MGBIG carbonate (FIG. 1a) and GBIG bicarbonate (FIG. 1b).

FIGS. 2a-2b. Left: Schematic illustration of continuous-flow direct-steam sorbent regeneration (DSR). Right: DSR reactor designed for direct steam regeneration of solid guanidine, where CO₂ is released from the guanidine carbonate.

FIGS. 3a-3c. FIG. 3a includes photographs of the experimental setup for direct steam regeneration. The left inset displays a batch DSR reactor with a heating tape wrapped around it. The right inset shows the state of GBIG cake before and after direct steam stripping (solids are produced by a micro-filter press). FIG. 3b is a photographic image of the steam regeneration process of MGBIG (sample used: 10 g; Experiment #6 in Table 1). FIG. 3c is a corresponding infrared image showing the temperature distribution in the reactor and in steam lines during direct steam regeneration.

FIGS. 4a-4h. FIG. 4a is a graph showing temperature and CO₂ gas profiles of the reactor during the regeneration of 5 g MGBIG-C with water consumption at 170 mL/h for steam generation, wherein the marker [I] indicates a temperature measurement on the exterior wall of the reactor, the marker [II] corresponds to the temperature measurement at the liquid outlet, and the marker [III] represents the temperature measurement within the reactor. Results correspond to Experiment 2 in Table 1. FIG. 4b shows a MGBIG-C sample (5 g) before and after steam regeneration. FIG. 4c is a graph showing temperature and CO₂ gas profiles of the reactor during 5 g MGBIG-C regeneration without steam injection. Results correspond to Experiment #1 in Table 1. FIG. 4d is a bar graph showing CO₂ removal efficiency. FIG. 4e is a graph showing temperature and CO₂ gas profiles of the reactor during the regeneration of 10 g of GBIG-C regeneration with water consumption at 170 mL/h (Experiment #20). FIG. 4f shows a GBIG-C sample (10 g) before and after steam regeneration. The upper inset presents a cross-sectional view of the regenerated MGBIG cake after steam regeneration, while the lower inset displays the solution collected from the bottom outlet after regeneration. FIG. 4g is a bar graph showing CO₂ removal efficiency. FIG. 4h is a graph showing the mass and CO₂ gas profile of 10 g of GBIG-C regeneration at 130° C. in a convection oven. The vertical arrows indicate interruption of CO₂ measurements due to mass measurements of the sample during which gas ventilation of the oven occurs.

FIGS. 5a-5b. FIG. 5a shows the time evolution of temperatures of air and solid molecules in MD simulations. FIG. 5b shows the time evolution of temperatures of water vapor and solid molecules. During the 20-ns simulation, no condensation of water was observed. Therefore, the difference between air and water is exclusively due to the heat transfer efficiency from the gas to the solid phase. A faster temperature decrease was observed for the vapor than for the air, and consequently, the solid temperature increases faster with vapor than with air.

FIGS. 6a-6b. FIG. 6a are photographs showing CO₂ desorption from MGBIG-C in water. 1 g of MGBIG-C and regenerated MGBIG were added in 5 mL of water. A reference is 6 g of water. FIG. 6b is a graph showing temperature and CO₂ desorption profiles of MGBIG-C in water.

FIGS. 7a-7b. Process block flow diagrams for MGBIG-C regeneration by steam (FIG. 7a) and conductive heating hot plate (FIG. 7b).

FIG. 8. Preliminary cost analysis of MGBIG regeneration by steam (left) and conductive heater (right) at 540 kiloton CO₂ capture per year.

### DETAILED DESCRIPTION

In the method described herein, a carbonate or bicarbonate salt of a bis(iminoguanidine) (BIG) carbon dioxide sorbent is first provided in solid form. In some embodiments, the carbonate or bicarbonate salt is crystalline. In other embodiments, the carbonate or bicarbonate salt is non-crystalline (amorphous). It is understood herein that the BIG carbon dioxide sorbent in the carbonate or bicarbonate salt is necessarily in its bis(iminoguanidinium) state, which may be a monoprotonated or diprotonated state. The term “bis(iminoguanidine)” or “BIG” is herein meant to encompass compounds that contain two separate iminoguanidine or iminoguanidinium moieties in their structure. Each iminoguanidine moiety has the formula=N—NH—C(═NH)NH₂. Similarly, each iminoguanidinium moiety (as found in the salt form) has the formula ═N—NH—C(═NH₂⁺)NH₂.

More particularly, the carbonate or bicarbonate salt of the BIG carbon dioxide sorbent has the following structure in which X^{m-} represents the carbonate or bicarbonate anion:

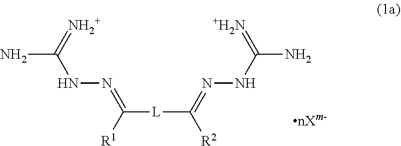

Notably, although Formula (1a) depicts a diprotonated form, Formula (1a) is intended to include monoprotonated forms, such as follows:

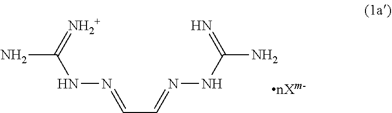 [SMILES: N=C(N)N/N=C/C=N/NC(N)=[NH2+]]

The variables R¹ and R² in Formula (1a) are independently selected from H and hydrocarbon groups containing 1-3 carbon atoms. Some examples of hydrocarbon groups containing 1-3 carbon atoms include methyl, ethyl, n-propyl, isopropyl, cyclopropyl, vinyl, and allyl groups. In some embodiments, R¹ and R² in Formula (1a) are independently selected from H and methyl groups. In some embodiments of Formula (1a), R¹ and R² are both H. In other embodiments of Formula (1a), one of R¹ and R² is H while the other is methyl. In other embodiments of Formula (1a), both R¹ and R² are methyl. In some embodiments, R¹ and R² may interconnect to form a saturated or unsaturated ring (e.g., cyclohexane or benzene ring).

In Formula (1a) or any sub-formula thereof, X^{m-} is a carbonate or bicarbonate anion, with m being 1 for bicarbonate and 2 for carbonate. In the case of the bis-iminoguanidine molecule being di-protonated, the variable n is an integer of 1 or 2, provided that n multiplied by m is 2 (i.e., n×m=2) to counterbalance the +2 charge of the di-protonated bis-iminoguanidinium species. In the case of the bis-iminoguanidine molecule being mono-protonated, the variable n is 0.5 or 1, provided that n multiplied by m is 1 (i.e., n×m=1) to counterbalance the +1 charge of the mono-protonated bis-iminoguanidinium species.

The variable L in Formula (1a) is a bond or a hydrocarbon linker containing 1-12 carbon atoms (e.g., alkylene, alkenylene, or ring-containing linker) and optionally containing one or more heteroatoms selected from O, N, and S. In the case of the hydrocarbon linker being an alkylene or alkenylene linker, the alkylene or alkenylene linker may be linear or branched. The alkylene linker may have the formula —(CH₂)ₙ—, wherein n is an integer from 1-12, or more particularly an integer from 1-8, 1-6, 1-4, 1-3, 2-4, or 2-6, and wherein one or more hydrogen atoms in the formula may be substituted by an equivalent number of methyl groups, provided that the hydrocarbon linker contains up to 12 carbon atoms. The alkenylene linker may contain 2-12 (or more particularly, 3-12, 3-8, 3-6, 4-12, 4-8, or 4-6) carbon atoms and one or two carbon-carbon double bonds. In the case of the hydrocarbon linker being a ring-containing linker, the ring-containing linker may be or include an aliphatic or aromatic ring, wherein the aliphatic or aromatic ring is typically five-membered or six-membered. In some embodiments, the ring-containing moiety is or includes a monocyclic ring, i.e., a single ring not bound or fused to another ring. In other embodiments, the ring-containing moiety is or includes a ring system, wherein the term “ring system” refers to a polycyclic moiety (e.g., a bicyclic or tricyclic moiety). The ring system can be polycyclic by either possessing a bond between at least two rings or a shared (i.e., fused) bond between at least two rings.

In one set of embodiments, L is a ring-containing moiety that includes a carbocyclic ring or ring system. The term “carbocyclic” indicates that the ring or ring system contains only carbon ring atoms. The carbocyclic ring or ring system can be saturated or unsaturated. Some examples of carbocyclic rings that are monocyclic and saturated include cyclopentyl, cyclohexyl, and cycloheptyl rings. Some examples of carbocyclic rings that are monocyclic and unsaturated (which may be aliphatic or aromatic) include cyclopentenyl, cyclopentadienyl, cyclohexenyl, cyclohexadienyl, cycloheptenyl, cycloheptadienyl, and phenylene (benzene) rings. Some examples of carbocyclic rings that are polycyclic and saturated include decalin, norbornane, bicyclohexane, and 1,2-dicyclohexylethane ring systems. Some examples of carbocyclic rings that are polycyclic and unsaturated include naphthalene, anthracene, phenanthrene, phenalene, and indene ring systems.

In another set of embodiments, L is a ring-containing moiety that is or includes a heterocyclic ring or ring system. The term “heterocyclic” indicates that the ring or ring system contains at least one ring heteroatom. The ring heteroatom is typically selected from nitrogen, oxygen, and sulfur. The heterocyclic ring or ring system can be saturated or unsaturated. Some examples of heterocyclic saturated rings or ring systems include those containing at least one ring nitrogen atom (e.g., pyrrolidine, piperidine, piperazine, imidazolidine, azepane, and decahydroquinoline rings); those containing at least one ring oxygen atom (e.g., oxetane, tetrahydrofuran, tetrahydropyran, 1,4-dioxane, 1,3-dioxane, and 1,3-dioxepane rings); those containing at least one ring sulfur atom (e.g., tetrahydrothiophene, tetrahydrothiopyran, 1,4-dithiane, 1,3-dithiane, and 1,3-dithiolane rings); those containing at least one ring oxygen atom and at least one ring nitrogen atom (e.g., morpholine and oxazolidine rings); and those containing at least one ring nitrogen atom and at least one ring sulfur atom (e.g., thiazolidine and thiamorpholine rings). Some examples of heterocyclic unsaturated rings or ring systems include those containing at least one ring nitrogen atom (e.g., pyrrole, imidazole, pyrazole, pyridine, pyrazine, pyrimidine, 1,3,5-triazine, azepine, diazepine, indole, purine, benzimidazole, indazole, 2,2′-bipyridine, quinoline, isoquinoline, phenanthroline, 1,4,5,6-tetrahydropyrimidine, 1,2,3,6-tetrahydropyridine, 1,2,3,4-tetrahydroquinoline, quinoxaline, quinazoline, pyridazine, cinnoline, and 1,8-naphthyridine rings); those containing at least one ring oxygen atom (e.g., furan, pyran, 1,4-dioxin, benzofuran, dibenzofuran, and dibenzodioxin); those containing at least one ring sulfur atom (e.g., thiophene, thianaphthene, benzothiophene, thiochroman, and thiochromene rings); those containing at least one ring oxygen atom and at least one ring nitrogen atom (e.g., oxazole, isoxazole, benzoxazole, benzisoxazole, oxazoline, 1,2,5-oxadiazole (furazan), and 1,3,4-oxadiazole rings); and those containing at least one ring nitrogen atom and at least one ring sulfur atom (e.g., thiazole, isothiazole, benzothiazole, benzoisothiazole, thiazoline, and 1,3,4-thiadiazole rings). In some embodiments, the ring-containing moiety is selected from benzene and nitrogen-containing aromatic rings (e.g., pyridine).

In the event that the variable L is a ring, Formula (1a) and sub-formulas thereof are intended to include any regioisomers that may differ in the connection points of the two iminoguanidine groups on the ring-containing moiety (L). Thus, as an example, if L is taken as a benzene (phenylene) ring, the two shown iminoguanidine groups may be located at the 1,4 (para), 1,3 (meta) or 1,2 (ortho) positions. In some embodiments, the iminoguanidine groups are located the farthest from each other on the ring-containing moiety. In the case of a benzene ring, the farthest positions correspond to the 1,4 (para) positions. In the event that the structure according to Formula (1a) possesses one or more stereocenters, Formula (1a) is intended to include all resulting stereoisomers. The stereoisomer may include one or more enantiomers and/or diastereomers.

Some examples of compounds according to Formula (1a) in which L is a ring-containing moiety include monoprotonated and diprotonated versions of the following BIG compounds:

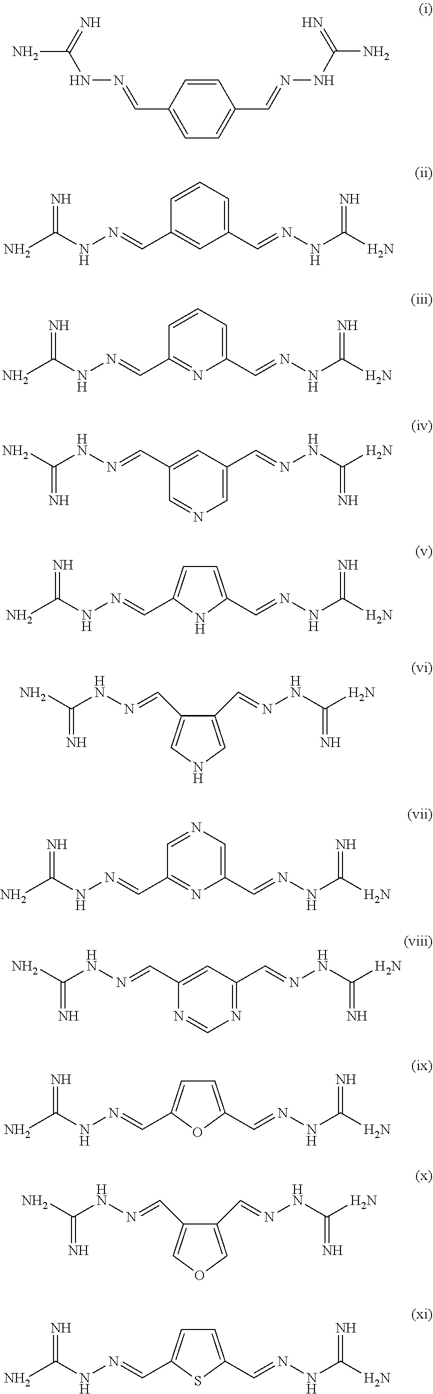

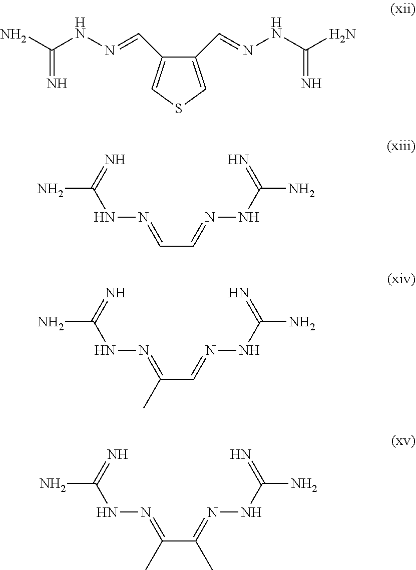 [SMILES: N=C(N)N/N=C/c1cscc1/C=N/NC(=N)N ; N=C(N)N/N=C/C=N/NC(=N)N ; CC(/C=N/NC(=N)N)=N\NC(=N)N ; CC(=N\NC(=N)N)/C(C)=N/NC(=N)N]

In any of the above exemplary BIG compounds, one or two methyl groups (or other hydrocarbon groups containing 1-12 carbon atoms) may or may not be present at the equivalent positions corresponding to R¹ and R² in Formula (1a). Moreover, when in the salt form, any of the above exemplary BIG compounds are understood to be present in the salt as their mono- or di-protonated form complexed with X^{m-}, which is a carbonate or bicarbonate anion, as shown in Formula (1a).

In particular embodiments of Formula (1a), L is a bond and the bis(iminoguanidinium) sorbent-CO₂ complex has the following structure:

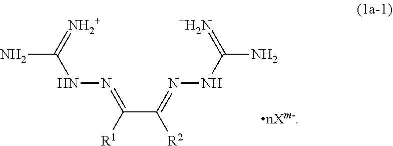

In some embodiments of Formula (1a-1), R¹ and R² are both H, which results in the compound glyoxal-bis(iminoguanidine), herein also referred to as GBIG. In other embodiments of Formula (1a-1), one of R¹ and R² is H while the other is methyl, which results in the compound methylglyoxal-bis(iminoguanidine), herein also referred to as MGBIG. In other embodiments, both R¹ and R² are methyl (DMBIG).

The structures of the protonated forms of GBIG, MBIG, and DMBIG are shown as follows:

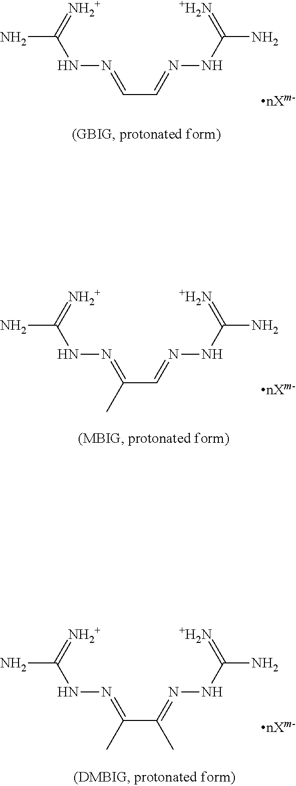

In other particular embodiments of Formula (1a), L is cyclic, such as an aromatic ring, as described above. Some particular examples of aromatic rings include phenylene, pyridinyl, cyclopentadienyl, and pyrrolyl rings. In particular embodiments, the bis(iminoguanidinium) sorbent-CO₂ complex has any of the following ion pair structures:

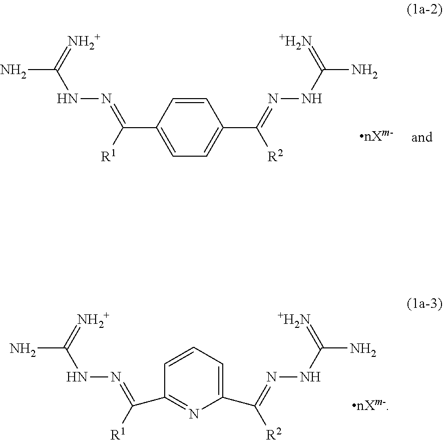

Any of the BIG structures provided in this disclosure are intended to include all possible tautomers, regioisomers, and stereoisomers. Thus, the positive charge shown in any of the formulas may be located on any of the other nitrogen atoms by tautomerizaton. As well known in the case of tautomers, the positive charge is generally distributed among all atoms capable of holding a positive charge in the various tautomers. Likewise, it is well known that partial double bond character is generally present among all of the bonds capable of engaging in double bonds in the various tautomers.

Moreover, the structures in any of the formulas may or may not include the possibility of one or more of the hydrogen atoms being replaced with one or more methyl groups. In a first set of embodiments for Formulas (1a-2) and/or (1a-3), R¹ and R² are both H. In a second set of embodiments for Formulas (1a-2) and/or (1a-3), one of R¹ and R² is methyl. In a third set of embodiments for Formulas (1a-2) and/or (1a-3), R¹ and R² are both methyl.

In the method for regenerating a BIG carbon dioxide sorbent, the carbonate or bicarbonate salt of the BIG carbon dioxide sorbent is directly contacted with steam heated to a temperature within a range of 80° C.-130° C. to result in regeneration of the BIG carbon dioxide sorbent with simultaneous conversion of the carbonate or bicarbonate anions into carbon dioxide and water. Thus, upon completion of the steam contacting step, the regenerated BIG carbon dioxide sorbent is uncharged and substantially removed of carbonate or bicarbonate. The uncharged BIG carbon dioxide sorbent may optionally contain one or more adduct water molecules. In different embodiments, the temperature of the steam contacting the carbonate or bicarbonate salt is precisely or about, for example, 80° C., 85° C., 90° C., 95° C., 100° C., 105° C., 110° C., 115° C., 120° C., 125° C., or 130° C., or a temperature within a range bounded by any two of the foregoing values, such as 80-130° C., 80-120° C., 80-110° C., 80-105° C., 80-100° C., 80-95° C., 80-90° C., 90-130° C., 90-120° C., 90-110° C., 90-105° C., 90-100° C., 90-95° C., 95° C.-105° C., 100-130° C., 100-120° C., 100-110° C., 110-130° C., or 110-120° C. A steam temperature of less than 100° C. can be achieved by reducing the pressure of the steam, whereas a steam temperature of greater than 100° C. (i.e., superheated steam) can be achieved by increasing the pressure and/or temperature of the steam. In some embodiments, the steam is permitted to contact the carbonate or bicarbonate salt of the BIG carbon dioxide sorbent at standard pressure (precisely or about 1 atm) at a temperature of precisely or about 100° C.

The steam is preferably wet steam, which contains droplets of water having any of the above temperatures. Thus, the term “steam,” as used herein, is also meant to include forms of water that simulate wet steam, such as a hot water spray which contains droplets having any of the above temperatures. During the contacting step, the hot water droplets condense onto the salt of the BIG carbon dioxide sorbent. Preferably, such as in the case of sorbents containing R¹ as a methyl group and R² as a hydrogen atom (or more particularly MGBIB, which contains L as a bond, R¹ as a methyl group, and R² as a hydrogen atom), the salt of the BIG carbon dioxide sorbent partially or completely dissolves in the condensed water before or during conversion of the bicarbonate or carbonate anion to carbon dioxide and regeneration of the uncharged form of the BIG carbon dioxide sorbent. In some embodiments, such as in the case of MGBIG, the uncharged form of the BIG carbon dioxide sorbent substantially dissolves in the condensed water to form an aqueous solution. In the case where dry steam is used, conditions should be employed to promote condensation of the heated water vapor onto the salt to partially or completely dissolve the regenerated (uncharged) BIG sorbent in the water to form an aqueous solution. For example, the BIG salt or surrounding walls of the vessel in which the BIG salt is contained may be maintained at a slightly reduced temperature than the steam to ensure condensation. The term “aqueous,” as used herein, refers to the presence of water. In some embodiments, the only liquid in the solution is water, while in other embodiments, the liquid in the solution may be water in admixture with a water-soluble organic solvent, such as an alcohol, acetone, or tetrahydrofuran.

In some embodiments, such as in the case of MGBIG, the aqueous solution containing the regenerated (uncharged) BIG sorbent is re-used for additional capture of carbon dioxide with resulting formation of a second crop of a carbonate or bicarbonate salt of the BIG carbon dioxide sorbent. The second crop of a carbonate or bicarbonate salt of the BIG carbon dioxide sorbent can then be treated by the above described regeneration method to produce a second generation of BIG (uncharged) carbon dioxide sorbent, which may again be re-used for additional capture of carbon dioxide and formation of a third crop of a carbonate or bicarbonate salt of the BIG carbon dioxide sorbent. The process can be repeated indefinitely any number of times.

The carbon dioxide that has been released from the salt can be either quarantined for storage for an unspecified amount of time or until it is used in another process, or the released carbon dioxide gas may be directly used in a process or converted to a useful chemical substance or feedstock as the carbon dioxide is released. In some embodiments, the evolved carbon dioxide gas is stored and/or pressurized, as appropriate, and may subsequently be further processed or reacted in an industrial or commercial process. The carbon dioxide may be conveyed to a process where the carbon dioxide is converted to, for example, dry ice, a hydrocarbon fuel, methanol, or ethanol.

The regenerated BIG carbon dioxide sorbent has the following generic structure, which may or may not contain one or more adduct water molecules:

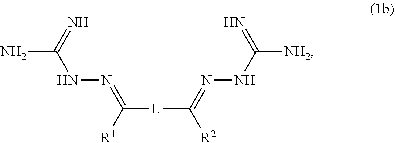

or more specifically, any of the following sub-generic or specific structures (wherein L may be selected as a bond or any of the hydrocarbon linking groups disclosed earlier above):

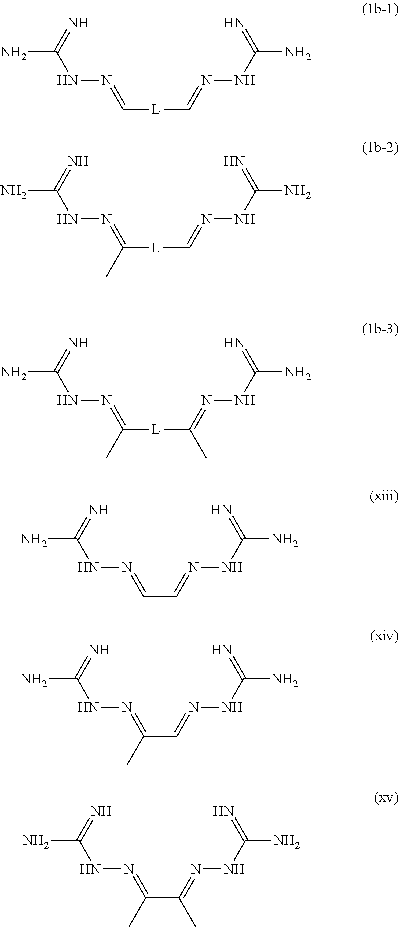

In Formula (1b) and sub-formulas thereof, the variables L, R¹, and R² are all independently selected according to any of the definitions provided above under Formula (1a) and sub-formulas thereof. The regenerated BIG sorbent may also be any of the specific unprotonated compounds (i)-(xv) shown above.

In some embodiments, the steam is heated by use of a renewable energy source, which may be practiced with or without a vacuum. The renewable energy source may be, for example, solar energy. In one embodiment, the solar energy is used for direct heating, such as in a solar heat concentrator (e.g., a solar oven). In another embodiment, the solar energy is used for indirect heating, such as by converting the solar energy to electricity or hydrogen, which is then used to power a heating device. Hydrogen may be used directly as a fuel, or indirectly in a fuel cell to produce electricity. Other forms of renewable energy (e.g., wind or hydroelectric power) may be used to produce electricity or hydrogen to power a heating device. Geothermal power may also be used directly or indirectly to heat steam or to function as the source of the steam. In some embodiments, a manmade heating process that employs a fuel that emits carbon dioxide when combusted is excluded in step (iii). The steam may also be waste steam, such as steam produced by an electrical power plant or a boiler.

The regeneration method described above may also be integrated with a process for producing the carbonate or bicarbonate salt of the BIG sorbent. The BIG sorbent that herein functions as a carbon dioxide complexing compound has a structure within the scope of Formula (1b) shown earlier above. In some embodiments, an aqueous solution of the BIG sorbent is contacted with a source of carbon dioxide to produce a precipitated bicarbonate or carbonate salt of the BIG sorbent. In other embodiments, the process for capturing carbon dioxide includes an initial capture of the carbon dioxide by an initial reactive sorbent that reacts with carbon dioxide to form an aqueous-soluble carbonate or bicarbonate salt of the initial reactive carbon dioxide sorbent, followed by reaction of the carbonate or bicarbonate salt of the initial reactive carbon dioxide sorbent with the BIG sorbent, such as any of those described above with the scope of Formula (1b), to produce a carbonate or bicarbonate salt of the BIG sorbent and regeneration of the initial reactive sorbent. After the BIG carbonate or bicarbonate salt is precipitated from the aqueous solution, the precipitate is removed (separated) from the aqueous solution to result in a solid form of the BIG carbonate or bicarbonate salt. Generally, the precipitated salt is filtered from the solution. If desired, the isolated salt may be rinsed and/or dried. The gaseous source can be any volume of gas containing carbon dioxide. The gaseous source can be, for example, air, waste gas from an industrial or commercial process, flue gas from a power plant, exhaust from an engine, or gas from a subterranean space (e.g., sewage or landfill gas).

The initial reactive CO₂ sorbent may be, for example, one or more organoamines, alkali hydroxides (e.g., NaOH or KOH), alkali carbonates (e.g., Na₂CO₃ or K₂CO₃), and/or alkaline earth hydroxides (e.g., Ca(OH)₂). The organoamines may be primary or secondary amines. Some examples of conventional organoamines include methylamine, ethylamine, ethylenediamine, ethanolamine, and amino acids. As well known, organoamines react with carbon dioxide to form ammonium bicarbonates and ammonium carbonates. As is also well known, metal hydroxides react with carbon dioxide to form metal bicarbonates and carbonates; and metal carbonates react with carbon dioxide to form metal bicarbonates. The initial reactive carbon dioxide sorbent can be present in any suitable concentration in the aqueous solution, e.g., 0.1, 0.2, 0.5, 1, 1.5, 2, 2.5, 3, 4, or 5 M concentration, or a saturated concentration, or a concentration within a range bounded by any two of the foregoing values.

The sorbent compounds according to Formula (1b) can be synthesized by methods well known in the art. In particular embodiments, compounds according to Formula (1b) are synthesized by reacting aminoguanidine (or a methylated derivative thereof) with a dialdehyde or diketone under conditions where an imine linkage is formed between an amino group on the aminoguanidine and the carbon of the aldehyde or ketone group. A general schematic of the process is provided as follows:

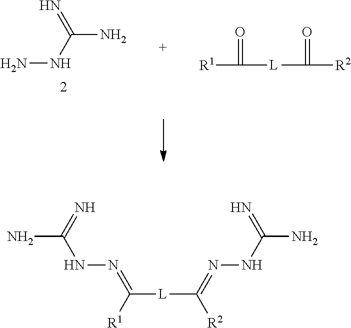

The above scheme is for directly producing a neutral bis-iminoguanidine compound according to Formula (1b). Alternatively, by reacting the aldehyde or ketone with a guanidinium compound, a guanidinium salt can be produced and converted to the neutral guanidine compound by reaction with a base. Moreover, any one or more hydrogen atoms of the aminoguanidine or aminoguanidinium reactant may be replaced with one or more methyl groups, respectively, except that the aminoguanidine or aminoguanidinium reactant should retain at least one primary amine group for reaction with the dialdehyde or diketone. Alternatively, one or more hydrogen atoms of the bis-iminoguanidinium or bis-iminoguanidine product may be replaced with one or more methyl groups by, for example, reaction with methyl iodide.

Examples have been set forth below for the purpose of illustration and to describe certain specific embodiments of the invention. However, the scope of this invention is not to be in any way limited by the examples set forth herein.

### Examples

### Overview

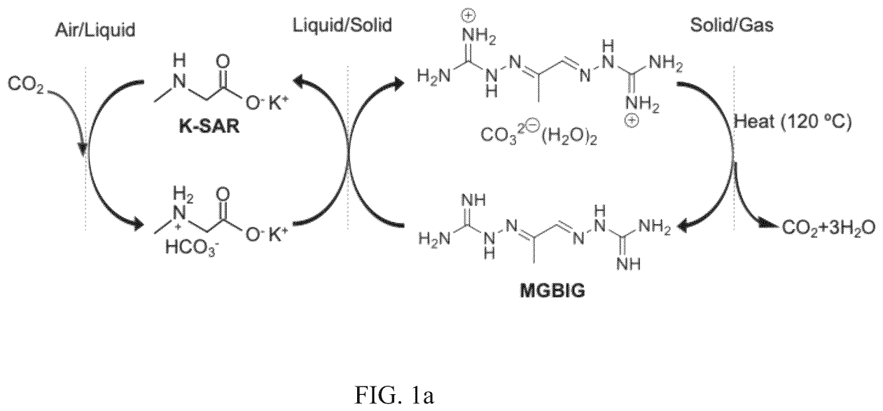

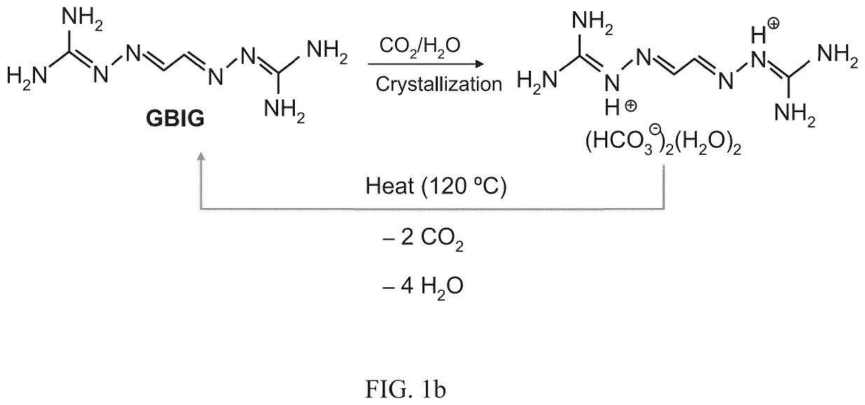

In conventional CO₂ capture processes, bis(iminoguanidine) (BIG) compounds have been used as CO₂ sorbents capable of capturing CO₂ from flue gas or air and crystallizing into insoluble hydrated carbonate salts, such as 2,6-pyridine bis(iminoguanidine), PyBIGH₂CO₃(H₂O)₄; glyoxal-bis(iminoguanidine), GBIGH₂(HCO₃)₂(H₂O)₂; or methylglyoxal-bis(iminoguanidine) (MGBIG) carbonate, (MGBIGH₂²⁺)(CO₃²⁻)(H₂O)₂. The captured CO₂ can be released by heating the carbonate crystals at relatively mild temperatures of 80-120° C., leading to the regeneration of PyBIG, GBIG, or MGBIG. MGBIG has been employed as DAC sorbent, combined with traditional aqueous sorbents such as amino acids (e.g., sarcosine or potassium sarcosinate (K-SAR)] that rapidly absorb atmospheric CO₂, followed by crystallization of BIG (bi)carbonate salts with very low aqueous solubilities. This phase-changing DAC process combines the advantages of aqueous amino acid solvents, such as rapid reaction rates with CO₂, low volatility, easy scalability, and environmental compatibility, with the benefits of solid-state adsorbents, such as lower temperatures (80-120° C.) and energy of regeneration. A schematic of these conventional processes is shown in FIG. 1a (for MGBIG) and FIG. 1b (for GBIG).

A cost-effective, energy-efficient sorbent regeneration process for phase-changing guanidines used for CO₂ capture has herein been developed based on direct-steam stripping. This approach enhances the regeneration rate, simplifies the overall CO₂ capture process, and reduces the energy cost compared to conventional conductive thermal regeneration. A direct-steam sorbent regeneration reactor was used to demonstrate that aqueous bis(iminoguanidines) (BIG) sorbents, e.g., methylglyoxal-bis(iminoguanidine) (MGBIG) and glyoxal-bis(iminoguanidine) (GBIG), can be efficiently regenerated with up to ˜99% CO₂ recovery through direct-steam stripping. Using low-temperature steam at 100° C., a 4.5 times faster regeneration rate for GBIG carbonate sorbent (e.g., 30 min for 10 g) was demonstrated compared to conductive-heating (e.g., 135 min for 10 g) at 130° C. Additionally, fully regenerated MGBIG was converted into an aqueous MGBIG solution when the steam condensed onto the sorbent surface. Condensed steam with the guanidine can be easily recycled as an aqueous solution into the gas-liquid contactor to achieve a continuous-flow CO₂-capture process. Molecular dynamics simulation was employed to provide a better understanding of the process. Higher heat transfer rates from steam to guanidine carbonate, compared to air heating, were attributed to the vibration resonance of water molecules within MGBIG with that of vapor molecules and the effective transfer of kinetic energy from vapor to solid. Technoeconomic analysis demonstrated that direct-steam stripping significantly decreases the CO₂ capture cost by 50% compared to traditional conductive heating methods. Enhanced mass transfer facilitated by low-temperature steam and subsequent condensation effectively heats up the H₂O-containing BIG-carbonate crystals, facilitating the desorption of CO₂ from the solid crystals, thereby leading to fast, effective, and energy-efficient sorbent regeneration.

### BIG Sample Preparation

Carbonate particles of MGBIG and GBIG were prepared to evaluate the efficacy of steam stripping. Solid MGBIG carbonate particles were synthesized based on a previously established method (G. G. Jang et al., Sep. Purif Technol., 309, 123053, 2023). GBIG was synthesized in accordance with a published procedure (N. J. Williams et al., Chem., 5, 719-730, 2019). For GBIG bicarbonate, a 4-L slurry of CO₂-loaded GBIG was prepared by bubbling pure CO₂ into an aqueous solution of 1 M GBIG. Upon reaction with CO₂, dissolved GBIG precipitated out of solution as GBIGH₂(HCO₃)₂(H₂O)₂, thereby creating a slurry that contained approximately 7.1 wt % solids. A press filter was used to separate out the solid particles from the slurry solution in a process driven by compressed air with a pressure of ˜100 psi. A polypropylene satin weave filter, with a rating of 2.4 to 3.2 cfm was used for the slurry filtration.

### BIG Sorbent Regeneration

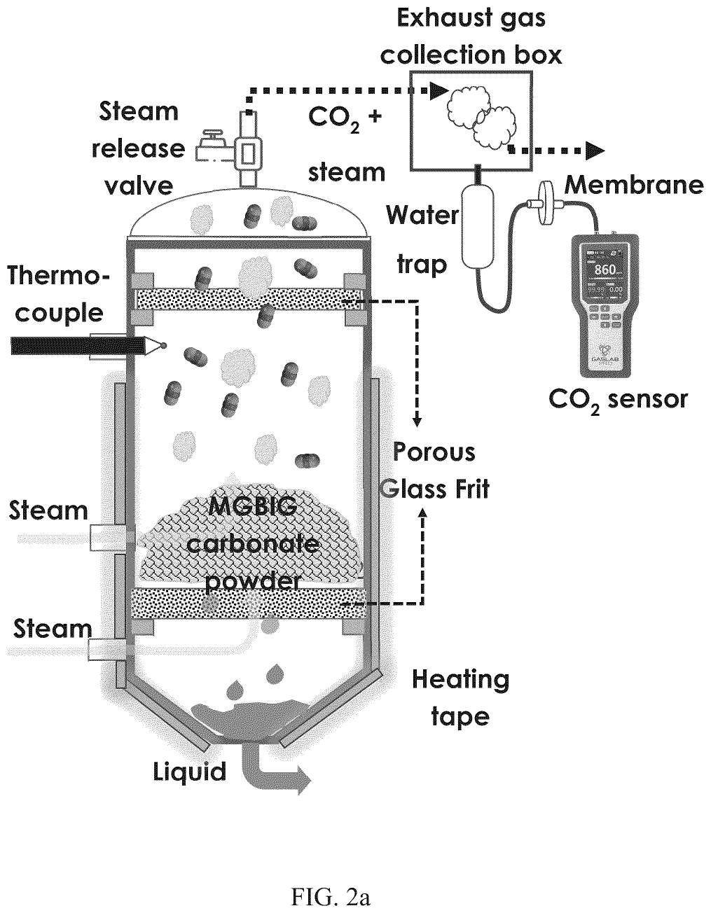

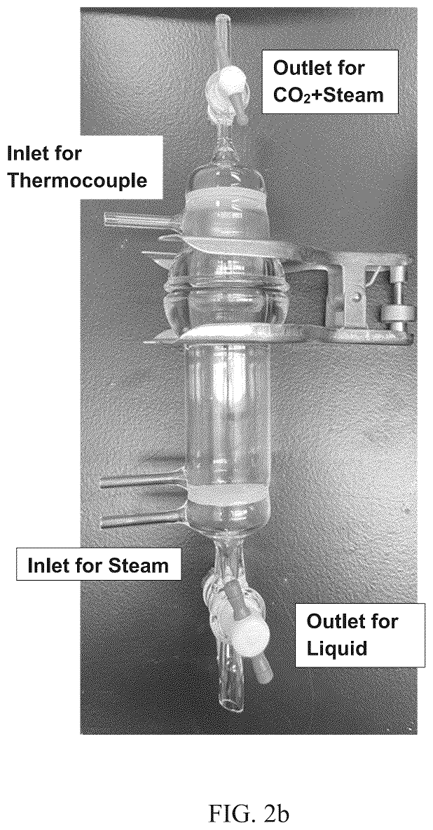

Direct steam stripping was carried out in a custom-built glass reactor (diameter of chamber x length: 5 cm×20 cm) as shown in FIGS. 2a-2b. Steam generated from a steam generator was fed into two inlets on the bottom of reactor. Porous glass frits were located at the top and bottom of the reactor to keep BIG carbonate solid particles over the bottom frit while allowing liquid to drain through the bottom frit and desorbed gases to escape through the top frit. A thermocouple was inserted into the top section of the reactor to measure the temperature of the gas inside the chamber. The DSR reactor was wrapped with heating tape to help control the temperature of the reactor and avoid water condensation on the inside wall. The exhaust steam and CO₂ passed through the top outlet of the reactor and the CO₂ concentration was measured in an exhaust gas collection box (50 50 50 cm³). The water mass consumed for steam generation was measured after each run. Conductive heating regeneration was also performed using a conventional oven (65 L) for comparison.

### Materials Characterization

Infrared sensors for CO₂ concentration measurements in the inlet and outlet gas streams were used. For gas sample measurements, the exhaust gas passed through a water trap and hydrophobic filter (CM-0118) prior to reaching the sensor to avoid excess water. A total inorganic carbon analyzer containing an acidification module and a CO₂ coulometer module was used to determine inorganic carbon content in solid samples. Air at 100 mL/min was used as a carrier gas, and calculations were based on sample weight. A 1 M Na₂CO₃ solution was used as a standard. Solid samples (40-60 mg) were weighed out into small Teflon cups, and the entire cup was transferred into a 15-mL sample flask. A volume of 5 mL of 2 M HCl acid was dispensed to acidify each sample. Solid samples were analyzed in duplicates. X-ray diffraction (XRD) measurements were conducted using an X-ray diffraction system equipped with a solid-state detector. For the XRD measurements, X-rays were generated at 45 kV/40 mA, and the X-ray beam wavelength was λ=1.5406 A (Cu Kα radiation). Nuclear magnetic resonance (NMR) measurements were performed to quantify solvent degradation after regeneration. The 1D spectra were recorded on a 400 MHz NMR spectrometer equipped with a 5 mm BBI or BBO probe. A residual solvent peak was used as an internal reference (DMSO-d6: 2.50 ppm).

### Molecular Dynamics

Molecular dynamics (MD) simulations were performed to understand the differences between vapor and air regeneration efficiencies observed in the experiments. The VMD tool (W. Humphrey et al., J. Mol. Graph. 14(1), 33-38, 1996) was utilized to visualize molecular configurations. Amorphous solids were built from the molecular components of MGBIG reported in a previous study (R. Custelcean et al., Chem Sus Chem, 13(23), 6381-6390, 2020). All molecules were generated from SMILES strings using Open Babel software (N. M. O'Boyle et al., J. Cheminf, 3(1), 33, 2011). The antechamber tool (J. Wang et al., J. Mol. Graph. Model, 25 (2), 247-260, 2006), was utilized to assign the General Amber ForceField (GAFF) (J. Comput. Chem. 25 (9) (2004) 1157-1174) parameters, which can describe the behavior of non-protein organic molecules. Appropriate point charges of the molecules were estimated through the AM1-BCC model (A. Jakalian et al., J. Comput. Chem. 23 (16) 1623-1641, 2002) through the antechamber tool. The TIP3P model (D. J. Price et al., J. Chem. Phys. 121 (20) (2004) 10096-10103) was utilized for water, and the parameters for N₂ and O₂ were obtained from a previous study (S. Wang et al., J. Chem. Theory Comput. 17 (8) (2021) 5198-5213). The Moltemplate program (A. I. Jewett et al., J. Mol. Biol. 433 (11) (2021) 166841) was utilized to build the initial geometries of MGBIG carbonate solid in a unit cell. All systems were charge-neutral, and the long-range electrostatic interaction was calculated through a particle-particle, particle-mesh (PPPM) method.

A slab system with an amorphous solid of MGBIG was prepared to increase the contact area with air and vapor. First, the 2×2×2 replication of the unit cell was prepared. A length of 5 Å in the unit cell was included in each axis to form a naturally amorphous phase. Firstly, NVT MD simulation was performed at 1000 K with the Berendsen thermostat for 10 ps with 1 fs timestep. Then, the temperature was decreased from 1000 K to 300 K in 10 ps. NPT MD simulation was subsequently performed with isobaric Berendsen barostat for 20 ps. The results indicated that, after these relaxations, the system was well connected along the z and y directions but had enough space along the x-axis.

Based on the assumption of the ideal gas, the amounts of water vapor and air (O₂:N₂=1:4) molecules were matched. The total number of gas molecules was set to 500. Imaginary walls between the gas and solid parts were set and relaxed at different temperatures. The solid part was set at 300 K, and the gas phase was set at 373 K. This system was good enough to distinguish differences in heat transfer from different gas molecules to solid molecules. It is noted that the experimental condition was for an open system. After removing the imaginary walls, the MD simulation was run for 2 ns, which was long enough to relax further both solid and gas phases at different temperatures. This relaxation was found critical, as air required a longer time step to relax. Then, the thermostats were removed and NVE MD was run for 20 ns to observe how the temperature of gas molecules and solid molecules evolved.

### Vibrational Density of State

The vibrational density of state (VDOS) was obtained from the Fourier transform of the velocity autocorrelation function (VACF) (G. S. Jung et al., Nanoscale 9 (36) (2017) 13477-13484).

First, the vibrational spectrum g(ω) was obtained as:

$$g ( ω ) = \frac{1}{\sqrt{2 π}} \int {e}^{i ω t} \frac{〈 v ( t ) v ( 0 ) 〉}{〈 v ( 0 ) v ( 0 ) 〉}$$

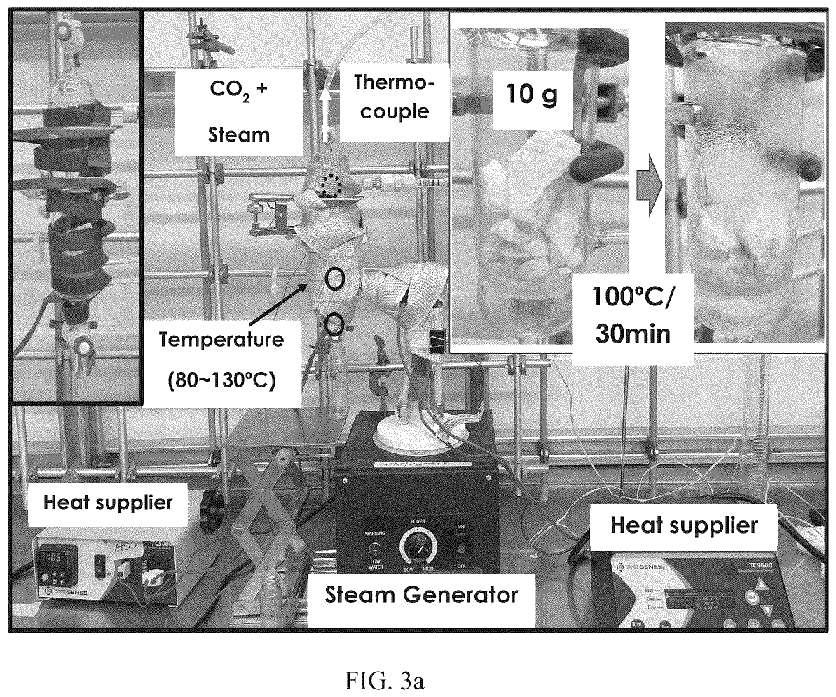

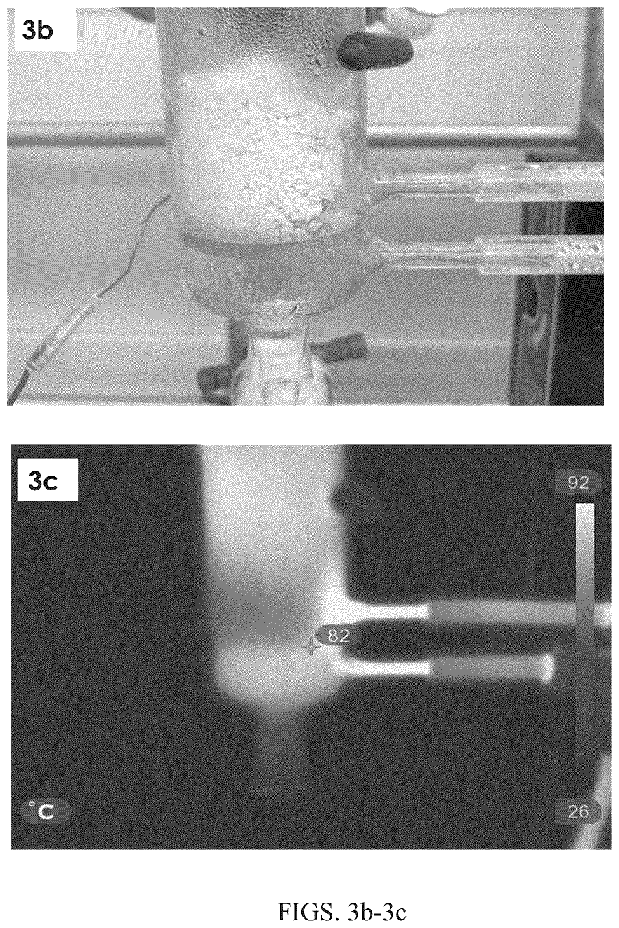

Three separate systems, i.e., air, water vapor, and MGBIC, were set up in the same dimensions as the system in FIG. 3c. After each system was relaxed for 50 ps at 373 K with a timestep of 1 fs, it was further relaxed for 25 ps with a timestep of 0.25 fs without the thermostat. Then, the VACF was obtained for 100 ps. Utilizing the Fourier transform, g(ω) and VDOS were then calculated from [g(ω)]2.

### Technoeconomic Analysis

Process models were conceptually developed at a scale of 540 kiloton CO₂ per year using a commercial process model and optimization software. Process models and simulations were performed as a standalone MGBIG-C regeneration process. Heat integration with upstream process (direct air contactor) and downstream process (CO₂ compression and sorbent recycle) were excluded in this analysis. Mass and energy balances were generated and used for process equipment design. Financial assumptions used in this cost analysis were consistent with U.S. DOE's analysis works (J. D. Peter Chen et al., U.S. DRIVE (Driving Research and Innovation for Vehicle efficiency and Energy sustainability) Net-Zero Carbon Fuels Technical Team Analysis Summary Report 2021, DOE Vehicle Technologies Office, DOE Office of Energy Efficiency & Renewable Energy, 2023) in which the “nth” plant assumptions were applied. This cost evaluation did not account for additional first-of-a-kind plant costs including special financing, equipment redundancies, large contingencies, and longer startup times necessary for the first few plants. Capital costs were derived from the literature and Aspen Capital Cost estimator software. Equipment cost, and operating costs (labor, utilities, materials) were integrated in a discounted cash flow spreadsheet calculation. All costs were presented in a 2020 constant US dollar basis.

### Results and Discussion

### Steam Regeneration: Experimental Implementation

Two phase-changing guanidine ligands, GBIG and MGBIG, as shown in FIGS. 1a and 1b, were investigated to understand the regeneration mechanism and evaluate the viability of direct steam regeneration. FIGS. 3a-3c show the experimental set-up employed for the direct steam regeneration of GBIG. The major objective of the reactor was to use steam to regenerate the sorbent sample and subsequently separate the regenerated GBIG in an aqueous solution for recycling. The procedure involved positioning a designated quantity of GBIG-C solid onto a porous frit located near the bottom of the reactor. A heating tape (as shown in leftmost inset in FIG. 3a) was wrapped around the reactor to prevent wall condensation and to control steam temperature within 80-130° C.

Steam, produced by a steam generator, was then introduced into the reactor above and below the bottom frit. The temperature of the steam used for stripping could be measured using a thermocouple, while the CO₂ concentration within the exhaust gases at the upper exit valve was measured using a CO₂ sensor. Following direct steam stripping, the GBIG-C sample volume, as shown in the rightmost inset photo of FIG. 3a, underwent a significant reduction due to CO₂ desorption and dissolution of the regenerated portion of the sample into liquid water, which passed through the bottom frit. FIG. 3b shows the process of direct steam regeneration for MGBIG-C without insulation (Experiment #6 in Table 1). An infrared (IR) image, as shown in FIG. 3c, was obtained to provide information on the temperature distribution inside the contactor and in the steam lines.

### Fast Steam Regeneration Using MGBIG

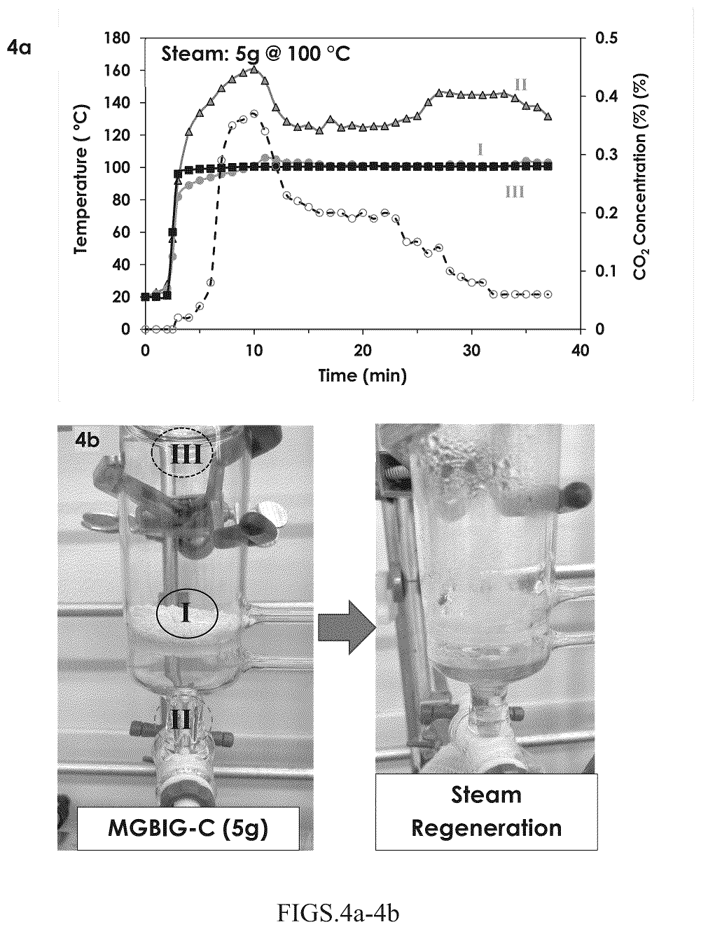

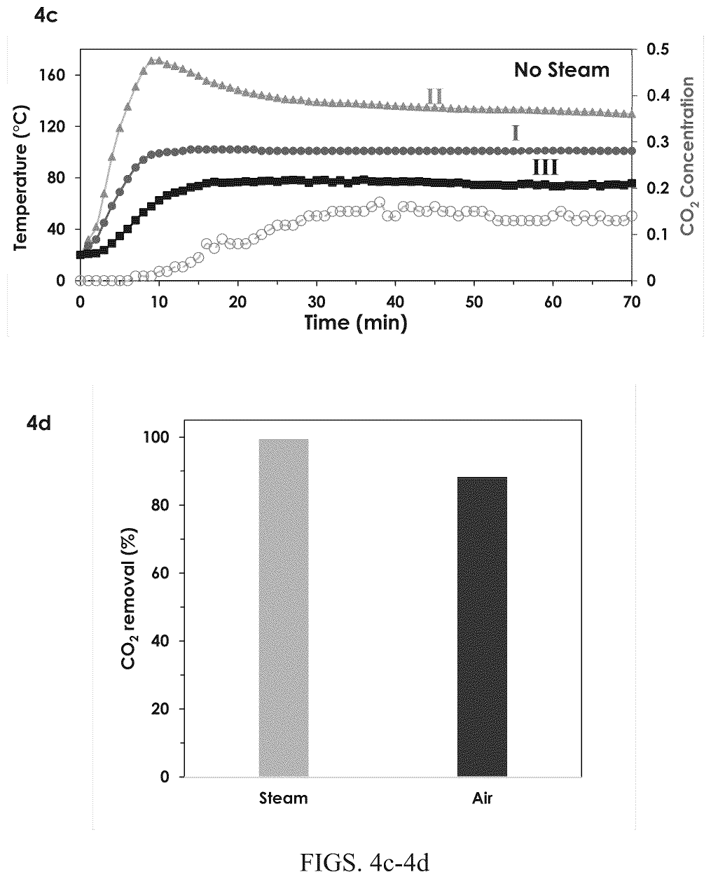

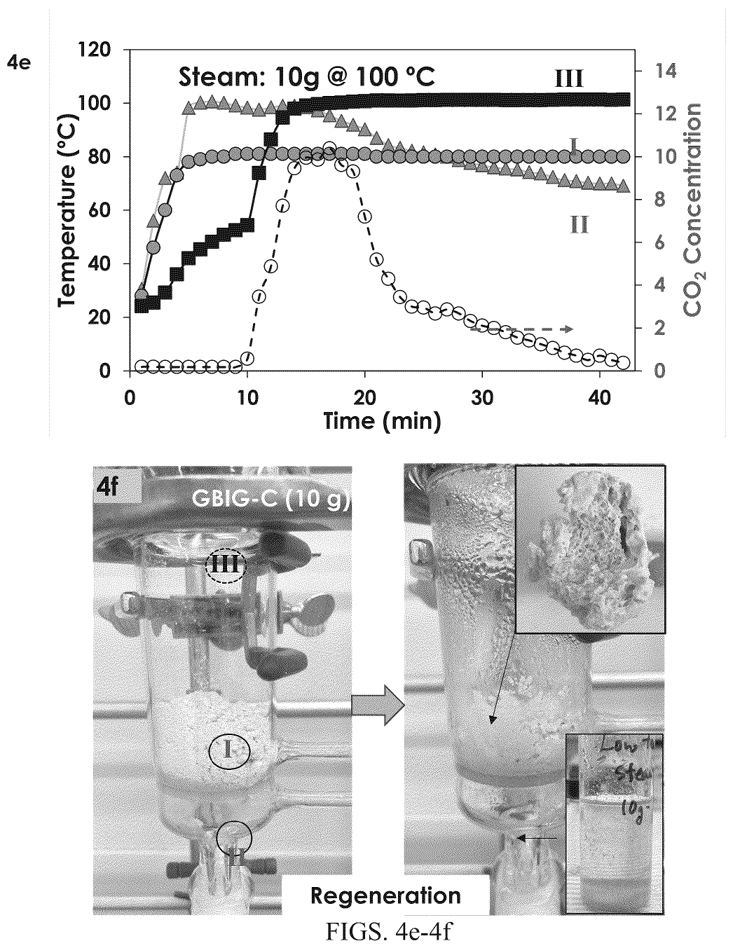

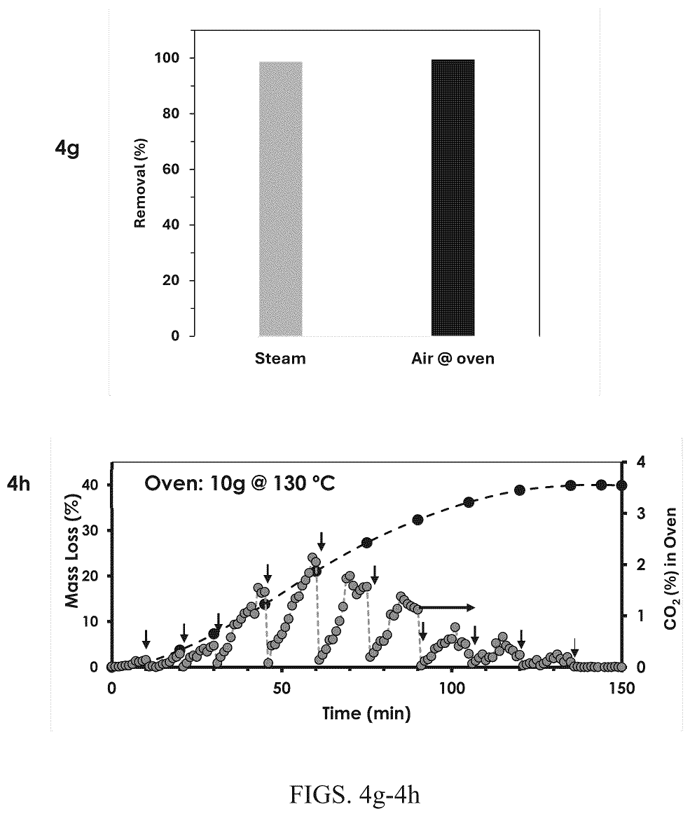

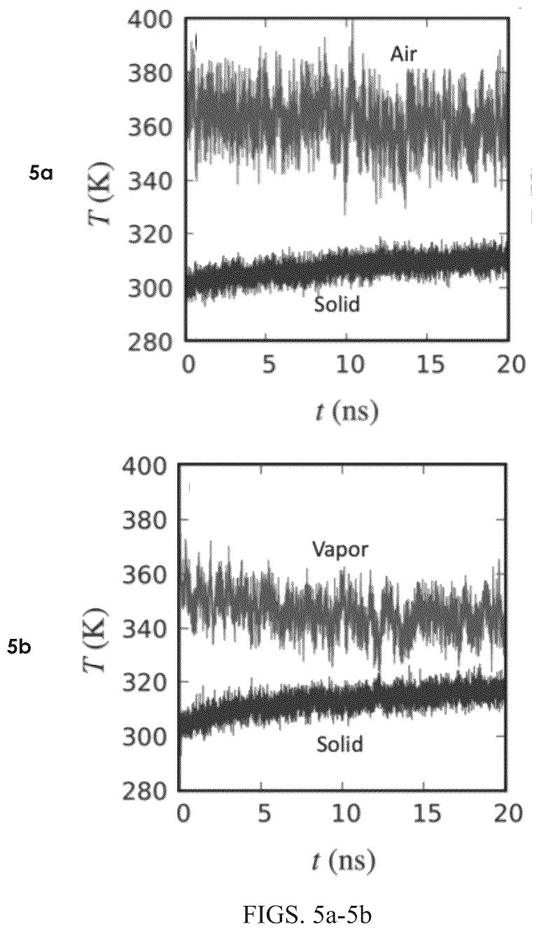

Temperature and CO₂ profiles, as shown in FIG. 4a, indicate that the desorption rate of CO₂ from MGBIG-C via direct steam stripping was much faster than that of CO₂ desorption without steam injection. The reactor temperature (designated as I in FIG. 4b) was maintained at 100° C. to prevent wall condensation. Due to the cross-wrapping of heating tape at the neck area, the temperature of the bottom area (designated as II in FIG. 4b) was higher than that of the reactor area. Monitoring reactor temperature profiles during CO₂ desorption elucidated the phase-change of MGBIG-C occurs during steam stripping.

In the initial stages, the temperature of the outflow steam (designated as III in FIG. 4b) rapidly increased to 100° C. as soon as steam was injected, predominantly heating up the MGBIG-C solid and reactor. After 5 min, a distinct surge of CO₂ desorption was observed for a few minutes. After 10 min, the rate of CO₂ desorption decreased with the temperature dropping at the bottom area (II), indicating a phase-change of MGBIG-C during CO₂ desorption. The steam-condensate solution, containing MGBIG, passed through the bottom glass frit and was collected in the bottom chamber, significantly decreasing the temperature compared to the baseline experiment without steam (FIG. 4c). After 25 min, the bottom temperature (II) increased, coinciding with a decrease in the CO₂ desorption rate after full regeneration. During this stage (i.e., 12-25 min), CO₂ desorption occurred from the liquid phase.

Upon heating, CO₂ desorbed from MGBIG-C, yielding free base MGBIG, which exhibited high aqueous solubility. However, MGBIG-C also dissolves to some extent, especially under high temperature. Additionally, it is possible that a portion of the desorbed CO₂ is reabsorbed by the MGBIG dissolved in water. The CO₂ desorption appeared to be completed after 30 min. Steam condensation was observed in the exhaust collection box. The relative humidity (RH) could be measured using the CO₂ sensor, but due to the water trap and hydrophobic filter placed before the sensor, RH values were only slightly elevated during steam regeneration. FIG. 4b shows that MGBIG dissolved into the liquid condensate upon CO₂ desorption. After cooling down to room temperature, some salts in the collected liquid sample precipitated out.

The supernatant solution and precipitated crystals contained 0.024 mol CO₂/L and 0.018±0.005% C (n=2), respectively (Table 1). The initial carbon content of MGBIG-C was measured at 4.20±0.05% C (n=4). Based on the carbon amount in the precipitated solid, it showed a 99.5% removal efficiency. With respect to mass balance, approximately 2 times the mass of water present in the MGBIG (MW=184 g/mol) sample used for regeneration was added. When MGBIG-C was fully regenerated to MGBIG, it approximately lost 34% of its mass, yielding approximately 3.3 g from the initial 5-g sample. Based on the volume of the liquid condensate (9.2 mL), the regenerated solution was estimated to be 1.9 M MGBIG, which exceeded the initial MGBIG concentration (0.3 M). In a continuous process, the high-concentration MGBIG in the regenerated stream will therefore need to be diluted prior to its reuse.

As a baseline experiment, 5 g MGBIG-C was regenerated without steam injection (FIG. 4c). Within 10 min, the reactor section (I) was heated up to 100° C. Then, CO₂ continuously desorbed over 1 h. The outflow steam (III) temperature was stabilized at 70° C. This temperature drop was due to heat losses in the reactor for MGBIG-C regeneration. As indicated in FIG. 4d, after 1 h of heating, the carbon content of MGBIG decreased to 0.492±0.128% C, representing 88.3% removal efficiency. Previous efforts indicated over 1.5 h to fully regenerate 5-10 g of MGBIG-C in a convection oven at 160° C.

Various operating parameters, such as isothermal heating temperature and sample amount, were also tested with the DSR reactor. Using a small amount of MGBIG (3-6 g), 93% removal efficiency was achieved with minimal water consumption (i.e., ˜10 mL). However, due to the small volume (30 mL) of the bottom chamber, when more than 5 g of MGBIG-C was tested (Experiments #5 and #6), the condensed MGBIG solution overflowed into the steam injection tube located below the bottom frit.

Consequently, these experiments were performed with the draining valve connected to the bottom chamber open, so that the regenerated MGBIG solution was continuously drained out. This approach resulted in 35-42% CO₂ removal, suggesting that a portion of CO₂ desorbed during phase-change, but complete desorption occurred after the liquid phase was collected in the bottom chamber. Thus, the residence time of the liquid and steam temperature in the DSR are important parameters in achieving high CO₂ removal efficiency. For a practical application of direct steam regeneration, a steam conveyor belt, may be used to effectively control the residence time and steam temperature.

### Fast Steam Regeneration Using GBIG

As shown by the graph in FIG. 4e, compared to MGBIG-C, GBIG carbonate (GBIG-C) was more effectively regenerated by steam stripping. In this case, the reactor temperature (I) was maintained at an isothermal temperature of 80° C. to prevent wall condensation. In the initial stages, the temperature of the outflow steam (designated as III in FIG. 4e) gradually increased, predominantly transferring heat to warm up the GBIG-C solid. After 10 min, a distinct surge of steam temperature was observed, coinciding with CO₂ desorption from the GBIG-C solid. Note that the bottom temperature (II) suddenly decreased around 15 min, which indicates the conversion of a portion of regenerated solids into liquid, likely associated with steam condensation. After the regeneration process, some solids remained on the glass frit, and approximately 10 mL of solution was collected from the bottom outlet. Upon cooling, salt crystallization occurred in the solution collector (inset image in FIG. 4f) due to solubility limitations. The supernatant solution and salt crystals contained 0.019 mol CO₂/L and 0.010±0.001% C (n=2), respectively. The regenerated solid piece on the glass frit exhibited a porous interior, indicative of CO₂ desorption. The regenerated solid contained 0.08±0.008% C (n=2). The initial carbon content of GBIG-C was measured at 6.25±0.98% C (n=4). The direct steam stripping process demonstrated a remarkable 99% removal efficiency for 10 g within 30 min. Half of the regenerated GBIG (MW=170 g/mol) was wet solid (3.2 g dry weight), and part of GBIG (2.8 g) dissolved into 9.6 mL of liquid. GBIG-C showed 40% mass loss after full regeneration. Thus, the regenerated solution was estimated to be 1.7 M GBIG.

Furthermore, when considering the baseline experiment, as shown in FIG. 5h, it is evident that steam stripping desorption is much faster than conductive heating desorption. Based on mass loss and final carbon content measurements, full regeneration of 10 g GBIG-C at 130° C. required 140 min, which is 4.5 times longer than steam stripping. The CO₂ desorption profile showed that the desorption rate gradually increased, reached a maximum at approximately 50% mass loss and then gradually decreased, which is significantly different from the steam stripping. This behavior suggests that the heat transfer rate for steam stripping is much greater than the heat transfer rate for conductive heating in air.

In other experiments, various regeneration temperatures were tested with different sample amounts, as shown in Table 1 (below), and the results support the conclusion that steam stripping effectively regenerates GBIG-C at a relatively low temperature, high enough to prevent steam condensation. The total regeneration energy for GBIG-C was estimated at 3.4 kJ/g-CO₂ (N. J. Williams et al., Chem., 5, 719-730, 2019). Due to the partial phase-change and the low regeneration energy, steam stripping is more effective for GBIG-C than for MGBIG-C. The energy required for the regeneration of MGBIG carbonate, for example, is 7.0-10.2 kJ/g-CO₂.

TABLE 1
Summary of direct steam regeneration and conventional
heating experiments for MGBIG and GBIG carbonate.

| | | | | | | | Liquid [% C] | |
|---|---|---|---|---|---|---|---|---|
| | | | | | | | Super- | Pre- |
| | | | | | Tem- | Solid | natant | cipita- |
| | | | | | perature | (Avg | (molCO₂)/ | tion |
| | | A- | | | (C.) | % C, | Reg. Liq. | [Avg |
| | | mount | Time | Water | Reactor/ | n = | Amount | % C, |
| | # | (g) | (min) | (ml) | Steam | 2) | [g, mL] | n = 2] |
| MGBIG- | 0 | — | Ref | — | — | 4.21 | — | — |
| C | 1 | 5 | 60 | 0 | 100/80 | 0.49 | — | — |
| | 2 | 5 | 30 | 85 | 100/100 | — | 0.024/ | 0.02 |
| | | | | | | | [9.2 mL] | |
| | 3 | 3 | 30 | 10 | 96/100 | — | 0.029/ | 0.19 |
| | | | | | | | [9.5 g, | |
| | | | | | | | 8.5 mL] | |
| | 4 | 6 | 30 | 10 | 95/100 | 0.22 | 0.023 | 0.28 |
| | 5 | 10 | 30 | 10 | 80/100 | — | 0.032 | 2.43 |
| | 6 | 10 | 20 | 115 | 88/100 | — | 0.025/ | 2.73 |
| | | | | | (no | | [35 g, | |
| | | | | | insulation) | | 33.4 ml] | |
| GBIG- | 7 | — | Ref | — | — | 6.25 | — | — |
| C | 8 | 1 | 30 | Oven | 95; | 3.23; | — | — |
| | | | | | 105; | 2.21; | | |
| | | | | | 115 | 1.91; | | |
| | | | | | 130* | 1.79 | | |
| | 9 | 1 | 30 | 180 | 130/132 | 0.03 | 0.002/ | 0.02 |
| | | | | | | | [4.5 mL] | |
| | 10 | 1 | 20 | 120 | 115/118 | 0.01 | — | — |
| | 11 | 1 | 30 | 175 | 95-115/ | 0.06; | 0.002- | 0.02- |
| | | | | | 100-120^{#} | 0.04; | 0.007 | 0.03 |
| | | | | | | 0.06 | [2.5- | |
| | | | | | | | 3 mL] | |
| | 12 | 3 | 30 | 175 | 95/100-112 | 0.03 | — | — |
| | 13 | 5 | 30 | 175 | 95/100-106 | 0.10 | — | — |
| | 14 | 10 | 30 | 175 | 95/100-109 | 0.08 | — | — |
| | 15 | 3 | 30 | 0 | 95/64-78 | 1.86 | | |
| | 16 | 3 | 30 | 10 | 95/72-103 | 0.06 | — | — |
| | 17 | 3 | 30 | 85 | 95/98-118 | 0.06 | — | — |
| | 18 | 3 | 30 | 165 | 95/100-112 | 0.04 | — | 0.02 |
| | 19 | 10 | 30 | 10 | 80/84 | 4.22 | | |
| | 20 | 10 | 30 | 85 | 80/101 | 0.07 | 0.02 | 0.01 |
| | | | | | | | [9.6 mL] | |
| | 21 | 10 | 135 | Oven | 130 | 0.04 | — | — |

*Experiments were repeated with increasing temperature.
^{#}Triplicate experiments were performed. The error range of all values is <10%.

Direct steam stripping permits higher heat transfer rates from the gas to the solid powder in the reactor due to several reasons: 1) Latent heat of vaporization: Steam has a high latent heat of vaporization, which means it can release a significant amount of thermal energy when it changes phase from a gas to a liquid. When steam condenses on a solid in the reactor, it releases this latent heat, transferring a large amount of energy (translation motion of vapor phase) to the solid. This thermal energy is much higher for steam than for dry air, which does not condense and has a lower heat capacity than water. 2) Convection: Steam creates a convection current inside the reactor. As it passes around the solid, it carries more heat than air does. Convection helps distribute heat evenly throughout the reactor, ensuring that the solid is heated uniformly. 3) Improved heat conductivity: Steam can improve the heat conductivity of the solid (vibrational motion of vapor). When steam condenses on the surface of the solid, it can penetrate the material, filling any free space or pores in the solid, thus enhancing the thermal contact between the steam and the solid, leading to fast and effective heat transfer.

A molecular dynamics (MD) simulation was employed to provide a better understanding of the differences in the regeneration behaviors between air and water vapor heating. FIGS. 5a and 5b show the results of the temperature change. The temperature of water vapor decreases faster than the temperature of air, and consequently, the temperature of solid molecules increases faster with water vapor than with air. In these simulations, no significant water condensation was observed because it was controlled. Simulation results indicated that the heat transfer rate between the solid phase and water vapor is intrinsically different from that between the solid phase and air without the effect of vapor condensation which can further enhance the heat transfer rate. The observed higher heat transfer rates from steam to guanidine carbonate, in contrast to air heating, can be attributed to the resonance vibration of water molecules that are crystallized within MGBIG with vapor molecules and the effective transfer of kinetic energy from vapor to solid.

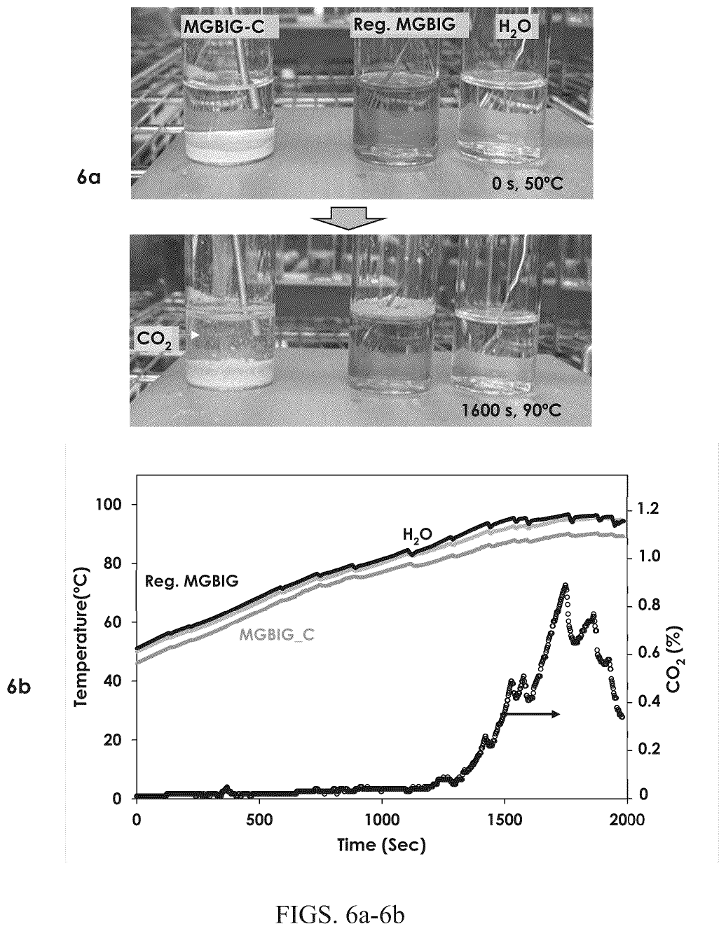

To provide a better understanding of the CO₂ desorption behavior of MGBIG-C within a water-saturated environment, experiments were conducted to investigate the temperature and CO₂ desorption profiles by heating MGBIG-C solid within water in a conventional oven. In this study, MGBIG phase 3, i.e., (MGBIGH₂²⁺)(CO₃²⁻)(H₂O)₂, wherein each MGBIG molecule binds with one molecule of CO₂ and two molecules of H₂O. The presence of water with CO₂ in the crystal results in water evaporation, which absorbs a significant portion of the regeneration energy (i.e., 7.0-10.2 kJ/g-CO₂). A breakthrough in achieving low-energy regeneration would involve releasing only CO₂ molecules while retaining H₂O molecules bound with the BIG compound. As shown in FIG. 6a, initially, at 50° C., MGBIG-C remains in a solid state, indicating no regeneration. Notably, fully regenerated MGBIG is completely dissolved in water. FIG. 6b shows that, upon heating the aqueous MGBIG-C solution to ˜78° C., CO₂ release was observed accompanied by a change in the color of the aqueous solution to yellow, indicating the progression of the desorption reaction. This observation suggests that a low-temperature and rapid regeneration process below 100° C. can be achieved in a water-saturated environment, potentially further reducing the latent heat (i.e., the enthalpy of evaporation) of water molecules from MGBIG-C (i.e., MGBIGH₂²⁺(CO₃²⁻)(H₂O)₂).

Low-temperature heating (<100° C.) in a water-saturated environment, such as steam-condensate, may be applicable to CO₂ desorption without water evaporation from the MGBIG and GBIG matrix, thereby significantly reducing the regeneration energy. Once CO₂ release from MGBIG-C is initiated in water, the regenerated MGBIG dissolves into the aqueous solution. Note that the temperature rise observed for MGBIG-C was relatively less pronounced than that observed for regenerated MGBIG solution and water. This behavior can be attributed to the heat of reaction associated with CO₂ desorption.

A comprehensive exploration of various operating parameters (as indicated in Table 1) influencing the CO₂ desorption performance was undertaken. All samples of GBIG (i.e., 1 g) were completely regenerated across different temperatures and compared to traditional convection heating. This efficiency holds even as the sample size increases to 10 g, reaching a 99% regeneration efficiency. Notably, when treating a 3 g sample size, the water amount needed for steam generation was reduced to 20 mL/h for the full regeneration. This behavior indicates that 0.3 g-GBIG sorbent/mL-H₂O was required for effective steam regeneration.

GBIG and MGBIG stability after steam stripping were studied by NMR and XRD analyses. ¹H-NMR analysis was performed on the suspended solution of regenerated MGBIG. No significant ¹H signal changes were found in the spectra for both regenerated MGBIG solution samples compared with the spectrum obtained for synthesized MGBIG. For solid samples, the XRD pattern of fully regenerated GBIG appears to be identical with the XRD pattern of fully regenerated GBIG via conventional heating for 6 hours. No chemical changes were observed, which indicates that no chemical degradation occurred during direct steam regeneration.

### Technoeconomic Assessment

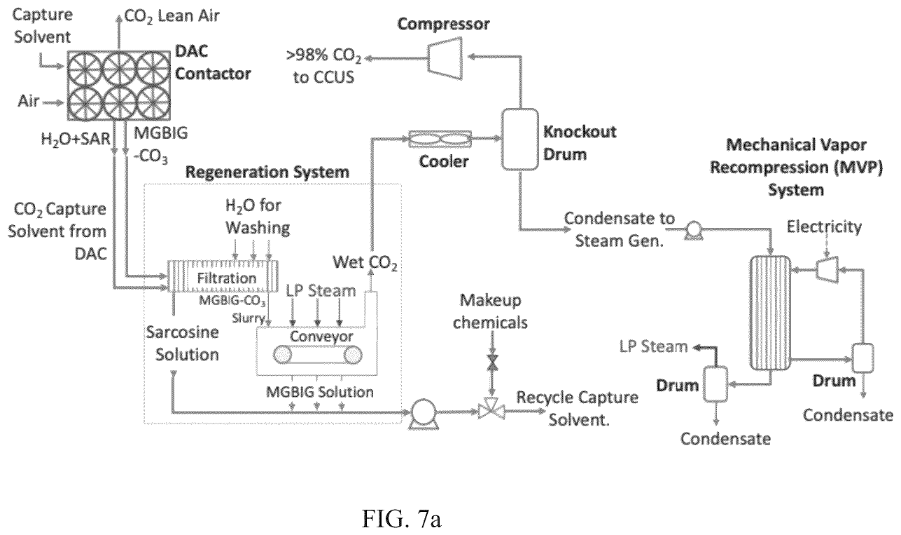

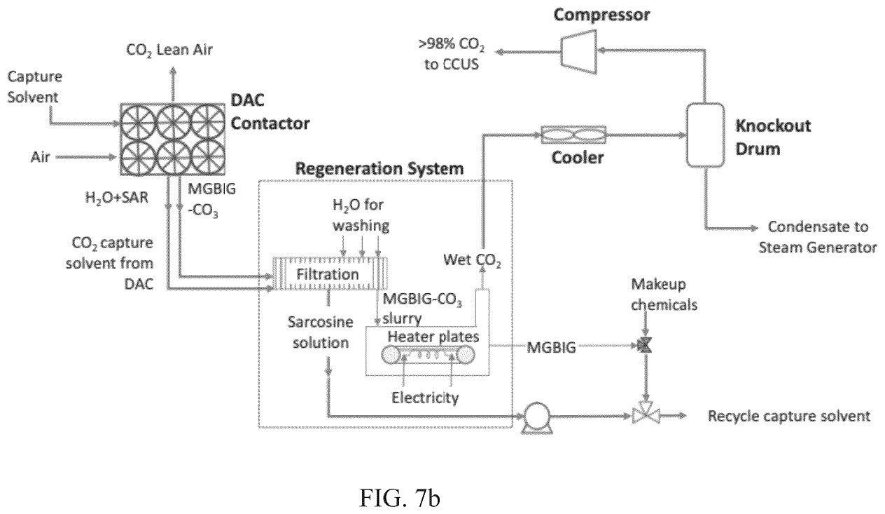

This analysis was performed to evaluate costs and process performances of two different MGBIG-C regeneration methods (using steam versus using heat conduction). Simplified process block flow diagrams with major unit operations are shown in FIG. 7. Most of the basic equipment, such as the pump, compressor, flash tank, and heat exchanger were manually designed and sized before the ASPEN Economic Evaluation tool was applied to estimate the equipment costs. For special design equipment, such as the air contactor and the MGBIG catalyst regeneration system, a known equipment design was used. The CO₂ capture solvent from a direct air contactor consists of solid MGBIG-C in aqueous potassium sarcosinate solution. A solid/liquid separation step is carried out by a filter press unit operation. Additional water is utilized to rinse MGBIG-C slurry at the filter press for a better potassium sarcosinate recovery efficiency. Washed MGBIG-C slurry (35% moisture content) from the filter press is then fed to the MGBIG-C regeneration unit where the slurry is heated up along conveyor belts in absence of air. For MGBIG-C regeneration by steam, low pressure steam (<125° C.) is fed directly to MGBIG-C slurry along the regeneration conveyor. A regeneration energy of 7.0 kJ/g-CO₂ at 100° C. (A. Kasturi et al., Sep. Purif Technol. 310 (2023) 123154) is used to estimate low pressure steam consumption. Mechanical vapor recompression (MVR) with a coefficient of performance (COP) of 8 is assumed to generate steam from electricity. The MVR unit allows this DAC technology to avoid generating additional CO₂ onsite in contrast to other DAC technologies that use a natural gas burner for their solvent/sorbent regeneration processes (D. W. Keith et al., Joule 2(8) (2018) 1635-1635). The regenerated MGBIG sorbent is dissolved in an aqueous phase and recycled back to the upstream direct air capture process. For conductive heating regeneration, MGBIG-C slurry from the filter press is heated to 100-135° C. by electrical heater plate conveyors. The product streams from this regeneration method include wet CO₂ and solid MGBIG. The cooler and knockout drum remove the moisture from the wet CO₂ in both steam and conductive heating processes. Solid MGBIG is recovered from the conveyor belts, dissolved in water, and sent back to the upstream process.

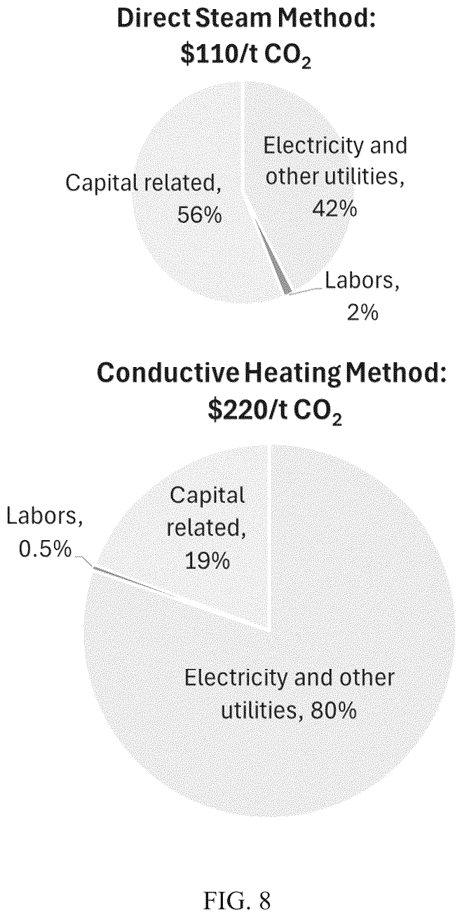

The preliminary economic evaluation indicates that the process economics of MGBIG-C regeneration by steam is more attractive. FIG. 8 includes pie charts showing preliminary cost analysis of MGBIG regeneration by steam (left) and conductive heater (right) at 540 kiloton CO₂ capture per year. As shown in FIG. 8, the cost of the steam MGBIG-C regeneration method is approximately $110/t CO₂ with approximately 56% capital cost and 46% utility cost. On the other hand, the cost of regenerating MGBIG-C by conductive heater plates is estimated at $220/t CO₂. The most significant cost driver for the conductive heating method is utility cost, which is about 80% of the total MGBIG-C regeneration cost. This is because using conductive heater plates is not as efficient as using steam for the MGBIG-C regeneration step. The experimental data also indicates that the rate of MGBIG-C regeneration was at least 3 times slower when the heat conduction (electric oven) was used. As a result, electricity consumption is much higher in the conductive heating process. Even though the conductive heating method is less efficient, its MGBIG-C regeneration capital cost is at least 30% less compared to the steam method ($42/t CO₂ for the conductive heater method vs $62/t CO₂ for direct steam method). MVR capital cost is found to be a capital-intensive unit, accounting approximately 20% of the capital cost of the steam MGBIG-C regeneration process. Generating steam on site can be avoided if waste heat or low-pressure steam is available nearby (such as located next to petroleum refinery or industry estate).

### CONCLUSIONS

Fast and efficient regeneration of solid CO₂ sorbents, including MGBIG and GBIG carbonates, was demonstrated by direct steam stripping. Low-pressure steam stripping at 100° C. significantly enhanced the efficiency of heat and mass transfer to MGBIG and GBIG carbonate solids, resulting in >4 times faster desorption rates, compared to the performance of conventional conductive heating. Molecular dynamics simulations confirmed that the resonance of molecular vibration of water molecules within MGBIG with that of vapor molecules significantly increases kinetic energy transfer from vapor to solid, resulting in superior heat transfer rates from steam to guanidine carbonate. Technoeconomic assessment revealed a 50% cost reduction with direct steam stripping compared to a traditional heat conduction method. Enhanced heat transfer and condensation of steam effectively heated CO₂-binding molecules, facilitating fast, efficient, and energy-saving sorbent regeneration.

While there have been shown and described what are at present considered the preferred embodiments of the invention, those skilled in the art may make various changes and modifications which remain within the scope of the invention defined by the appended claims.

What is claimed is:

1. A method for regenerating a bis(iminoguanidine) carbon dioxide sorbent, the method comprising:
(i) providing a carbonate or bicarbonate salt of the bis(iminoguanidine) carbon dioxide sorbent having the following structure, which may optionally contain one or more adduct water molecules: 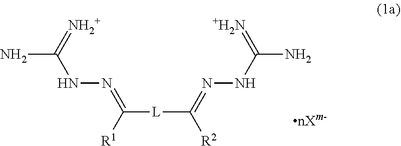
wherein:
L is a bond or a hydrocarbon linker containing 1-12 carbon atoms and optionally containing one or more heteroatoms selected from O, N, and S;
R¹ and R² are independently selected from H and hydrocarbon groups containing 1-3 carbon atoms;
X^{m-} is a carbonate or bicarbonate anion, with m being 1 for bicarbonate and 2 for carbonate; and
n is an integer of 1 or 2;
provided that n×m=2; and
(ii) directly contacting the carbonate or bicarbonate salt of the bis(iminoguanidine) carbon dioxide sorbent with steam or hot water heated to a temperature within a range of 80° C.-130° C. to result in regeneration of the bis(iminoguanidine) carbon dioxide sorbent with simultaneous conversion of the carbonate or bicarbonate anions into carbon dioxide, wherein the regenerated bis(iminoguanidine) carbon dioxide sorbent is substantially removed of carbonate or bicarbonate and may optionally contain one or more adduct water molecules;
wherein the regenerated bis(iminoguanidine) carbon dioxide sorbent has the following structure, which may optionally contain one or more adduct water molecules:

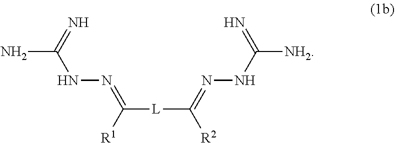

2. The method of claim 1, wherein L is a bond.

3. The method of claim 1, wherein R¹ and R² are hydrogen atoms.

4. The method of claim 1, wherein at least one of R¹ and R² is a methyl group.

5. The method of claim 1, wherein R¹ is a methyl group and R² is a hydrogen atom.

6. The method of claim 1, wherein L is a bond and R¹ and R² are hydrogen atoms.

7. The method of claim 1, wherein L is a bond and at least one of R¹ and R² is a methyl group.

8. The method of claim 1, wherein L is a bond, R¹ is a methyl group, and R² is a hydrogen atom.

9. The method of claim 1, wherein L is a five- or six-membered ring.

10. The method of claim 9, wherein the five- or six-membered ring is an aromatic ring.

11. The method of claim 10, wherein the aromatic ring is a benzene or pyridine ring.

12. The method of claim 1, wherein the steam is heated to a temperature within a range of 90° C.-120° C.

13. The method of claim 1, wherein the steam is heated to a temperature within a range of 90° C.-110° C.

14. The method of claim 1, wherein the steam is heated to a temperature within a range of 95° C.-105° C.

15. The method of claim 1, wherein the steam is heated to a temperature of 100° C.

16. The method of claim 1, wherein the regenerated bis(iminoguanidine) carbon dioxide sorbent is dissolved in water condensing from the steam during the contacting step to form an aqueous solution of the regenerated bis(iminoguanidine) carbon dioxide sorbent.

17. The method of claim 16, wherein R¹ is a methyl group and R² is a hydrogen atom.

18. The method of claim 16, wherein L is a bond, R¹ is a methyl group, and R² is a hydrogen atom.

19. The method of claim 16, wherein the aqueous solution is re-used for additional capture of carbon dioxide with resulting formation of a second crop of a carbonate or bicarbonate salt of the bis(iminoguanidine) carbon dioxide sorbent.

20. The method of claim 19, wherein a second generation of bis(iminoguanidine) carbon dioxide sorbent is regenerated from the second crop of a carbonate or bicarbonate salt of the bis(iminoguanidine) carbon dioxide sorbent according to the method in claim 1.

21. The method of claim 1, wherein the steam is waste steam.
